(19) United States
(12) Patent Application Publication
(10) Pub. No.: US 2008/0038042 A1
(43) Pub. Date: Feb. 14, 2008

(54) WATCH WITH COSMETIC APPLICATOR

(76) Inventor: Laura E. Guy, San Francisco, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/463,272

(22) Filed: Aug. 8, 2006

(51) Int. Cl. B43K 21/08

(52) U.S. Cl. 401/75

(57) ABSTRACT

A watch having a display which displays an output from a mechanism, the display and mechanism encased in a watchcase which includes a recess for releasably receiving an applicator is disclosed. A first end of the applicator features an application member with an amount of cosmetic pre-absorbed to the application member. Insertion of the applicator closes an electric circuit having a voltage potential for displaying the output. Removal of the applicator opens the electric circuit, removing the output from the display and revealing a mirror which is useful for application of the cosmetic.

### BACKGROUND OF THE INVENTION

In general, the present invention relates to timepieces. More particularly, the present invention relates to a watch having a removable cosmetics applicator.

Wristwatches come in a variety of types including, but not limited to, mechanical windup watches, self-winding or “automatic” mechanical watches, electric or electronic (i.e., battery-powered) analog watches, battery-powered wristwatches with digital time displays (LED (light emitting diode) and constant-display LCD (liquid crystal display)) and analog quartz timing devices.

Cosmetic containers have been well described in the art. A principle aim of cosmetic containers is to increase the carrying convenience of the container such that a user will have the container at the ready without a requirement of rummaging through a purse, pack, or rucksack.

Various attempts have been made to combine a watch with a cosmetics container. For example, U.S. Pat. No. 6,002,651 teaches a combination makeup compact and watch having a cosmetic compartment connected about a hinge to a watch mechanism compartment. The cosmetic compartment includes a slot for securing an applicator; the slot separating at least two beds of cosmetic in a powder or cake formulation. A user exposes the cosmetic compartment and a mirror by lifting the watch mechanism about the hinge, and applies the cosmetic using the applicator. However, the cosmetic compartment of the '651 device is fixed to the watch mechanism through a friction fit and can only be changed by changing an entire cosmetic tray. The '651 device thereby permits a user to change the cosmetic in accordance with a user's often mercurial cosmetic preference only at a significant replacement cost. However, mirrors and solid cosmetic formulations are subject to fracture even with slight impact, including the normal forces such as impact or shock that can be caused by the watch striking an object or surface inadvertently while being worn. Such an impact could fragment the mirror and/or cosmetic and render them useless.

Of foremost inconvenience, the '651 device does not integrate the cosmetic into the applicator. Instead, a user is required to remove the applicator, then absorb the cosmetic to the applicator tip which is then brushed to the user's preferred skin surface(s).

Accordingly, there is a need for a watch which integrates a cosmetic compound into an applicator that can be secreted in a housing of the watch, the applicator having a preabsorbed cosmetic which can be applied directly to a user on-the-go. The present invention fulfills these needs and provides other related advantages.

### SUMMARY OF THE INVENTION

The aforementioned shortcomings in the art are addressed by the present invention which is directed toward a watch having a display for displaying an output from a mechanism, the display and mechanism encased in a watchcase. The watchcase includes a recess for releasably receiving an applicator. A first end of the applicator features an application member with an amount of cosmetic pre-absorbed to the application member. Insertion of the applicator completes an electric circuit with a voltage potential for displaying the output. Removal of the applicator opens the electric circuit, removing the output from the display and revealing a mirror.

It is an object of the present invention to provide a new and improved cosmetics applicator.

It is another object of the present invention to provide a new and improved cosmetic applicator which is concealed within a watch.

Yet another object of the present invention is to provide a new and improved mirror for use with a cosmetic applicator concealed within a watch.

Still another object of the present invention is to provide a new and improved cosmetic applicator which is durable even while concealed within a watch.

Other features and advantages of the present invention will become apparent from the following more detailed description, taken in connection with the accompanying drawing which illustrate, by way of example, the principals of the invention.

### BRIEF DESCRIPTION OF THE DRAWINGS

The accompanying drawings illustrate the invention. In such drawings:

FIG. 1 is a perspective view of a watch, watchcase, watch band, and applicator in accordance with an embodiment of the present invention;

FIG. 2 is a perspective view of another embodiment of a watch, watchcase, watchband and applicator (with the applicator inserted in the watchcase) of the present invention;

FIG. 3 is a side perspective view of the watch of FIG. 2;

FIG. 4 is a side perspective view of the applicator of FIGS. 1 and 2; and

FIG. 5 is a simplified block diagram of a watch mechanism constructed in accordance with the present invention.

### DETAILED DESCRIPTION OF THE PREFERRED EMBODIMENTS

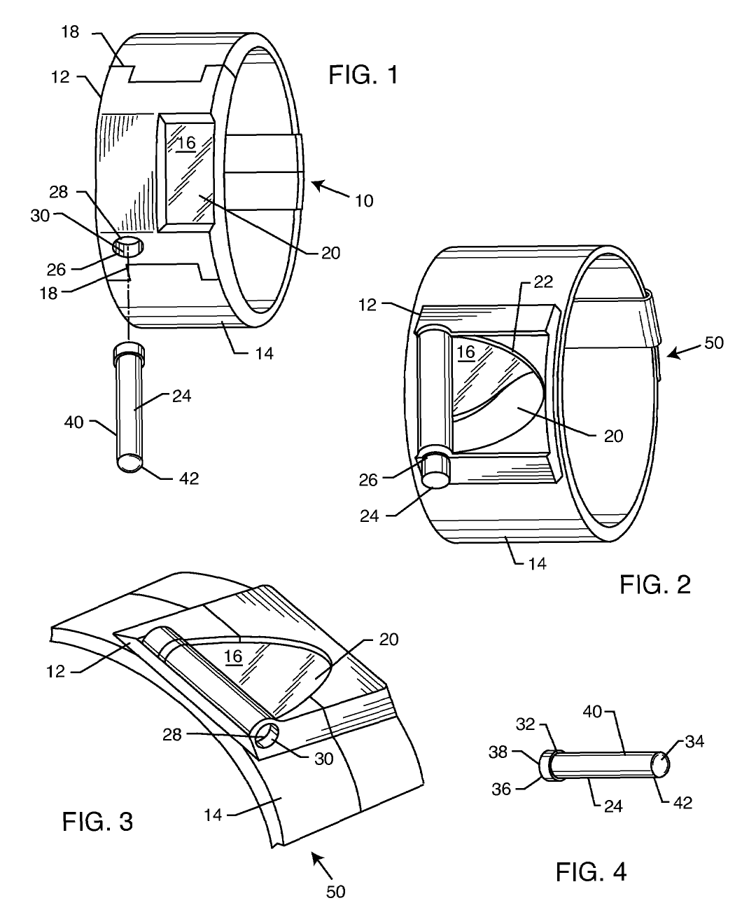

Reference is first made to FIG. 1, which represents a perspective view of a watch 10 constructed in accordance with one aspect of the present invention. By way of example, the watch 10 is an electronic timepiece which includes a watchcase 12, a band 14, and a display 16. The watchcase 12 may be constructed of any resilient material which can protect an electronic mechanism 42 contained therein (as well as the display 16 associated with the electronic mechanism) from incident impact while the watch 10 is being worn about a user's wrist. Suitable materials include, but are not limited to, any of a variety of durable materials such as polycarbonate resin, natural rubber, aluminum, gold (plated or solid), platinum (plated or solid), stainless steel, silver, plastic or the like. In the alternative, gem stones may be embedded on the surface of the watchcase 12. The band 14 secures the watch 10 to the user's wrist. The band 14 can be any of the type that have been well described in the art as pliable attachment means which provide adjustable circumferences. Various types of bands 14 inlcude, but are not limited to, a leather strap, a plastic strap, a metal strap or a combination of the aforementioned types of straps. Although FIG. 1 shows the watchcase 12 attached to the band 14 with an attachment mechanism 18 (e.g., pins connecting a band link to the watchcase 12 or the like), alternative embodiments of the present invention may feature the band 14 as an integrated strap of the same material as watchcase 12.

The display 16 comprises a mirrored surface, such as a mirror 20, coupled to a liquid crystal display (LCD) 22 capable of displaying a digital output from the electronic mechanism 42. FIG. 1 illustrates the watch 10 in an “off” mode in which an applicator 24 is vacant from a recess 26 in the watchcase 12. The display 16 is described in further detail infra.

In accordance with the present invention, the watch 10 comprises the recess 26 capable of receiving the applicator 24. The recess 26 has physical dimensions and shape which are complementary to the applicator 24 such that the applicator 24 is secured inside the recess 26 by a friction fit. More in particular, the recess 26 has a depth which is less than the length of the applicator 24. The recess 26 is characterized as having an aperture 28 which is complementary in shape to the frontal cross section of the applicator 24. Although the applicator 24 is depicted in FIG. 1 as being cylindrical, and the aperture 28 of the recess 26 is characterized as being circular, it will be understood that frontal cross-section of the applicator 24 and the aperture 28 shapes can be a combination of any complementary shapes which permit the applicator 24 to be securely inserted into the recess 26 through the aperture 28. The combination of complementary shapes for the applicator 24 and the aperture 28 may therefore assume myriad amusing shapes including cubic, elliptical, and star shapes. The watch 10 is designed so that the generally cylindrical applicator 24 is mostly contained within the watchcase 12 which presents a generally smooth curved surface above the applicator 24 next to the slightly rectangular display 16.

Various other aspects of the applicator 24 will be further described in the following diagrams and accompanying explanation.

Referring next to FIG. 2, a perspective view of a watch 50, similar to the watch 10, with the applicator 24 inserted in the watchcase 12 is illustrated, in accordance with another embodiment of the present invention. FIG. 2 illustrates the watch 50 in an “on” mode in which the LCD 22 displays an output comprising alphanumeric symbols, such output generally well-characterized in the art. A user turns on the display 16 of the watch 50 (as well as the watch 10) by securely inserting the applicator 24 in the recess 26. The LCD 22 is capable of displaying an output from the electronic mechanism 42 on the display 16. A positive click is registered when the applicator 24 is fully inserted into the recess 26 of the watchcase 12, providing the user with both tactile and aural feedback to indicate that the applicator 24 is fully secured. In this manner, the engagement of the applicator 24 and the watchcase 12 serves as a switch for turning the LCD 22 “on” and “off”.

Directing attention to FIG. 3, a side perspective view of the watch 50 is provided with the applicator 24 fully within the recess 26 of the watch 50. The applicator 24 has been removed from the recess 20 for use by a user (not shown) in order to use the applicator 24 for cosmetic application. The watch 50 is thereby rendered in an “off” mode. The recess 26 may include a ring 30. The ring 30 may be constructed of any pliable and compressible material that is durable and resistant to water, and substantially resembles an O-ring in function. When the applicator 24 is inserted into the recess 26, the ring 30 forms a flush-fit against an annular segment of the applicator 24. With applicator 24 so inserted, a substantially airtight and waterproof compartment is formed in the recess 26. The ring 30 additionally provides a frictional fit which secures the applicator 24 in the recess 26. Once inserted into the recess 26, the applicator 24 is kept substantially free from environmental insult include ambient moisture and incidental impact from contact which may occur to the watch being worn by the user. The watch 50 is designed so that the generally cylindrical applicator 24 is mostly contained within the recess 26 of the watchcase 12 where the recess 26 is part of a semi-cylindrical raised portion on the face of the watchcase 12, next to a slightly recessed, semi-elliptical display 16.

As illustrated in FIG. 3, the ring 30 is located along an interior aspect of the aperture 28. However, it will be understood that the ring 30 can be placed at any location along the length of the recess 26, from the aperture 28 inward, that would facilitate the ring's 30 flush fit with the applicator 24 and that does not compromise the substantially airtight and waterproof protection afforded when the ring 30 is placed along the aperture 28.

Operation of the display 16 will now be described. Generally, the display 16 comprises the mirror 18 and the LCD 22 encased in the watchcase 12. The LCD 28 with the mirror 18 can be any of a type currently known in the art which permits displaying of LCD information through a mirror. For more, see http://plasma-led.ru/pdf/philips%2023HM8801%20hallway%20mirror%20TV.pdf. While the watch 50 is illustrated in “off” mode in FIG. 3, no output is displayed on the LCD 28 and the user may use the mirror 18 for strategic application of cosmetic with the applicator 24. The present invention thus provides for a single-unit convenience of having a cosmetic applicator on hand which can be used with an integrated compact mirror.

The applicator 24, as seen in FIG. 4, comprises a first end 32, a second end 34, and a conductive element 40 intermediate of the first end 32 and second end 34. An application member 36 is located at the first end 32, the application member 36 bearing a pre-absorbed cosmetic 38. In a general sense, it shall be understood that “cosmetic” as used with respect to the preabsorbed cosmetic 38 may include, but not be limited to, a broad variety of powder, liquid powder, or liquid formulation with which a cosmeceutical consumer application may be delivered. Thus, the pre-absorbed cosmetic 38 may include lipgloss, lipstick, eyeshadow, eyeliner, and mascara, or any other cosmeceutical application that will absorb to the application member 36. The amount of cosmetic to be preabsorbed may vary with the particular formulation to be applied. The applicator 24 may be dosed with a preabsorbed cosmetic sufficient for one or greater application. By way of example, and not limitation, a lipstick applicator may likely carry a larger amount of pre-absorbed cosmetic for repeated application because the area to which the cosmetic will be applied is subject to frequent tissue sloughing and contact. Conversely, a one time applicator may be appropriate for eye-liner cosmetics, the eye not generally subject to frequent contact which would degrade the aesthetic value of the cosmetic application.

When the user wishes to secure the applicator 24 and turn the watch “on”, as seen in FIG. 2, the application member 36 on the first end 32 is inserted into the recess 20.

Preferably, the length of the applicator 24 is greater than the depth of the recess 26. When the applicator 24 is fully inserted into the recess 26, the second end 34 of applicator 24 protrudes slightly from the watchcase 12. The watch 10, 50 may be adapted to different applicators having substantially the same cross section but featuring various lengths, the particular length chosen to suit the user's preference. The second end 34 may have a gripping element 42 which permits the user to more easily remove the applicator 24 by pulling on the second end 34. The gripping element 42 can be any construct or coating which increases the coefficient of friction at the second end 34. In a preferred embodiment, the gripping element 42 can be a rubberized non-slip ring. Alternatively, the second end 34 can feature an array of bumps or ridges which provide for greater tactile security when handling the applicator 24.

As opposed to the watch 10, 50 which will be retained by the user, the applicator 24 may be a disposable unit and will preferably be constructed of a plastic or other semi-rigid material amenable of a low cost of manufacture. Positioned along the length of the applicator 24, intermediate of the first end 32 and the second end 34, is a conductive element 40. The conductive element 40 may comprise a circumference of conductive materials about the applicator 24, preferably copper sheeting, having a conductance sufficient for supplying the electronic mechanism 42 with an electrical potential from a battery 44 disposed within the watchcase 12.

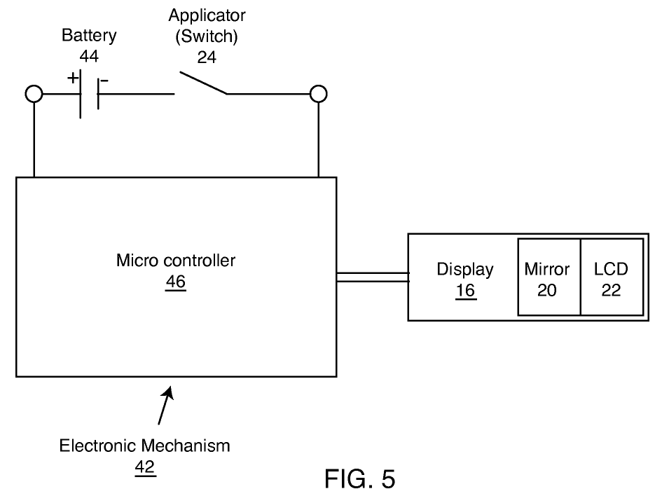

Directing attention to FIG. 5, the applicator 24 functions as a switch in the mechanism 44, which will now be described. Generally, the electronic mechanism 44 includes the battery, a microcontroller 46 (e.g., microprocessor), the applicator 24, and the display 16 components of the LCD 22 and the mirror 18. While not necessary to an illustration of the present invention, those skilled in the art will recognize that the electronic mechanism 42 may also include various other items such as a backup battery and a transducer for emitting sounds, both of which would be coupled to the microcontroller 46. The microcontroller 46 supplies output to the display 16 in the form of time (hour, minute, seconds), date, day or the like. The microcontroller 46 can also provide a stopwatch function or the like.

Operation of the watch 10, 50 in accordance with the present invention comprises an “on” and “off” mode. In the “on” mode, full insertion of the applicator 24 closes electrical contacts inside the watch 10, 50 by placement of the conductive element 40 in the power circuit of the watch 10, 50 so as to change the electrical potential on an integrated circuit input pin in the microprocessor 46, signifying a switch closure. Upon closure of the switch, the microprocessor 46 produces an output which is rendered on the display 16. When the applicator 24 is removed in the “off” mode, the power circuit of the device is opened, and the microprocessor 46 output is precluded from displaying on the mirror 20. In this fashion, the user may use the applicator 24 to turn the device on or off and thereby access the mirror 20 for use in applying the pre-absorbed cosmetic 38 on the application member 36 to a preferred skin surface.

It will be apparent to those skilled in the art that various modifications and variations can be made to a device embodying the present invention. For example, where a watch to be worn on the wrist has been described, it shall be understood that the present invention shall incorporate a watch which can be worn off the wrist, as for example, a timepiece held to an article of clothing by a chain or fob. Thus, it should be understood that the invention is not limited to the examples discussed in the specification. Rather the present invention is intended to cover modifications and variations as fall within the true spirit and scope of the invention.

What is claimed is:

1. A watch comprising:
a display for displaying an output from a mechanism, the display and mechanism enclosed in a watchcase;
a recess in the watchcase; and
an applicator releasably received into the recess.

2. The watch of claim 1, wherein a first end of the applicator comprises an application member.

3. he watch of claim 2, wherein the application member has a preabsorbed cosmetic.

4. The watch of claim 1, wherein insertion of the applicator into the recess closes electrical contacts inside the mechanism allowing the display to display the output.

5. The watch of claim 1, wherein the display further comprises a mirror and a liquid crystal display.

6. The watch of claim 5, wherein removal of the applicator from the recess opens electrical contacts inside the mechanism, preventing the output from displaying on the display, thereby exposing the mirror.

7. The watch of claim 1, wherein a second end of the applicator extends slightly from the watchcase.

8. The watch of claim 7, wherein the second end has a gripping element for easy removal from the recess.

9. The watch of claim 1, wherein the recess comprises a pliable ring for providing a flush fit around the applicator.

10. The watch of claim 1, wherein the recess comprises a locking means for securing the applicator when inserted.

11. A watch comprising:
a display having a mirror and a liquid crystal display for displaying an output from a mechanism, the display and mechanism enclosed in a watchcase;
a recess in the watchcase; and
an applicator releasably received into the recess having a first end comprising an application member including a preabsorbed cosmetic.

12. The watch of claim 11, wherein insertion of the applicator into the recess closes electrical contacts inside the mechanism allowing the display to display the output.

13. The watch of claim 11, wherein removal of the applicator from the recess opens electrical contacts inside the mechanism, preventing the output from displaying on the display, thereby exposing the mirror.

14. The watch of claim 1, wherein a second end of the applicator extends slightly from the watchcase.

15. The watch of claim 14, wherein the second end has a gripping element for easy removal from the recess.

16. The watch of claim 11, wherein the recess comprises a pliable ring for providing a flush fit around the applicator.

17. The watch of claim 11, wherein the recess comprises a locking means for securing the applicator when inserted.

18. A watch comprising:
a display having a mirror and a liquid crystal display for displaying an output from a mechanism, the display and mechanism enclosed in a watchcase;
a recess in the watchcase including a pliable ring;
an applicator releasably received into the recess having a first end comprising an application member including a preabsorbed cosmetic and a second end comprising a gripping element for easy removal from the recess, wherein the second end extends slightly from the watchcase; and
a locking means for securing the applicator in the recess when inserted;
wherein insertion of the applicator into the recess closes electrical contacts inside the mechanism allowing the display to display the output; removal of the applicator from the recess opens electrical contacts inside the mechanism, preventing the output from displaying on the display, thereby exposing the mirror; and the pliable ring provides a flush fit around the applicator.
